(19) United States
(12) Patent Application Publication
(10) Pub. No.: US 2020/0130073 A1
(43) Pub. Date: Apr. 30, 2020

(54) CUTTING DEVICE

(71) Applicant: RHEINMETALL WAFFE MUNITION GMBH, Unterluess (DE)

(72) Inventors: Tobias MODEREGGER, Bischofswiesen (DE); Rainer GAISBAUER, Schoenau (DE); Benjamin HUBER, Salzburg (AT); Thomas LEOPOLD, Harzgerode (DE)

(73) Assignee: RHEINMETALL WAFFE MUNITION GMBH, Unterluess (DE)

(21) Appl. No.: 16/725,393

(22) Filed: Dec. 23, 2019

Related U.S. Application Data
(63) Continuation of application No. PCT/EP2018/065257, filed on Jun. 11, 2018.

(30) Foreign Application Priority Data
Jun. 22, 2017 (DE) 10 2017 113 857.9

(51) Int. Cl. B23D 15/14; F42C 7/12; B23D 15/04

(52) U.S. Cl. CPC B23D 15/145; B64D 17/386; B23D 15/04; F42C 7/12

(57) ABSTRACT

A cutting device having a spring that is compressed. After a firing pin retainer has travelled a predetermined path, a locking element is released. The release results in the spring being released, causing the firing pin to be accelerated and at the end to strike a percussion cap, whereby a pyrotechnic charge therein is ignited and thereby a delay element, if provided, is lit. This delay element regulates the delay time. Afterwards, an additional charge is ignited. The gas volume thus generated applies pressure to the cutting element. Above a certain pressure the shear pin shears off, causing the cutting element to be axially accelerated. The cutting element strikes the stop at high speed as a result of the acceleration, and penetrates into same. A connection to be cut, which is guided through an opening in front of the stop, is thereby severed.

This nonprovisional application is a continuation of International Application No. PCT/EP2018/065257, which was filed on Jun. 11, 2018, and which claims priority to German Patent Application No. 10 2017 113 857.9, which was filed in Germany on Jun. 22, 2017, and which are both herein incorporated by reference.

### BACKGROUND OF THE INVENTION

### Field of the Invention

The present invention relates to a cutting device for severing at least two subassemblies which are connected to one another via a mechanical connection. The invention relates, in particular, to a cutting system for severing a braking system from a munition. The munition can be, for example, a submunition for generating a decoy target.

### Description of the Background Art

Following a delay time usually programmed during the launch, it is necessary for submunitions to be separated from the actual carrier, for example a rocket. During this separation, the submunition is accelerated. However, the resultant speed is too high for the effect and the stability of the decoy target itself. Therefore, the submunition has to be braked to a defined speed. In order to ensure this braking operation, the submunition, prior to being fully deployed, is braked by means of a brake parachute. Following a predetermined amount of time, said brake parachute has to be detached from the overall submunition system, so that the decoy target is not braked to too pronounced an extent. The detachment operation is performed, in practice, by a cutting device. This cutting device, designed in the form of a cable-cutting and wire-cutting device, severs a cord, for example made of aramid fibers, after approximately 0.6 seconds after the cutting device has been triggered. The time can be set in a variable manner by means of a preferably pyrotechnic delay element. The type of medium which is to be severed is defined. The performance capability of the cutting device can be adjusted, for example by way of different pyrotechnic compositions, different blade materials and different blade geometries. As a result of the severing operation, the brake parachute is jettisoned and the main parachute activates the decoy target.

Such a munition is disclosed in DE 87 11 922 U1. At the end of a braking phase, a cassette part, together with a brake parachute, is detached. A further munition with a brake parachute is described in DE 196 44 380 A1.

DE 10 2005 010 125 A1, which corresponds to U.S. Pat. No. 7,475,625, which is incorporated herein by reference, discloses a munition which, for programming purposes, has a galvanic line, for example a cable. The latter is to be severed at the earliest possible point in time of the firing operation. For this purpose, the munition has a severing device, which comprises mainly a piston which is guided in a rigidly mounted cylinder and has a preferably sharp edge. The cable is guided securely, in a protective tube connected to a propellant-charge primer, to the tip of the propellant-charge primer and, in addition, to the rear end of the projectile. In the upper region of the cylinder, the cable is guided through a bore located in a direction transverse to the direction of acceleration. When the piston moves forward, the cable is then served by the sharp edge.

In practice, in addition to such mechanical cutting devices, there are different electrical cable cutters, all based on the principle of stored energy. The disadvantage here, however, is that the duration of use is limited by the storage medium. In the case of mechanical cutting devices, the storage medium would be, for example, prestressed springs; in the case of electric cutting devices, the storage medium would be, for example, batteries. In particular in the case of electric cutting devices, the latter are very sensitive to electromagnetic interference and electrostatic discharge. These influencing factors mentioned pose a risk to the function chain of cutting devices based on an electric initiator/electric bridge ignitor. Interference and electrostatic discharge can cause these to be activated inadvertently.

### SUMMARY OF THE INVENTION

It is therefore an object of the present invention to provide a cutting device which, even under harsh environment conditions, reliably ensures that at least two subassemblies connected to one another via a mechanical connection are severed.

The invention is based on the concept of dispensing with the principle of stored energy and of using the braking energy of a brake parachute to subject a firing pin to stressing via a compression spring. Above a defined tensile force of the brake parachute, the firing pin is freed. Said firing pin here strikes against a primer cap, which initiates a pyrotechnic delay composition. Once the delay composition has burnt out, the cutting device is activated. This takes place, for example, by virtue of the actual charge of the cutting device being ignited. The charge here should be high-energy material. For this purpose, the cutting device comprises at least one pyrotechnic charge for generating a gas pressure, which then ensures that a mechanical cutting element of the cutting device performs the severing operation.

An advantage of a cutting device made in such a way is that the cutting device can manage without any previously stored energy. The function chain of the cutting device is based on a purely mechanical principle. Energy for igniting the pyrotechnic compositions is added to the munition system by the delay effect of the brake parachute. Furthermore, the cutting device is unaffected by electrostatic discharge and electromagnetic interference, since use is made purely of pyrotechnic compositions.

Burning of the charge suddenly generates a high gas volume. This gas volume accelerates a cutting element, e.g. a chisel, corresponding to a cutting device. Until the point at which it is accelerated, the chisel is held in position via a shear pin until a certain quantity of gas has been generated and the associated pressure is appropriately high for it also to be possible for the shear pin to be sheared off. Once the shear pin has been sheared, the chisel moves at high speed along a guide, which has a connection which is to be severed guided to its end. The chisel comes into contact with said connection and strikes therewith against a disk, for example a brass disk, located behind. This striking action severs the connection.

The invention proposes a cutting device having at least one firing-pin holder, at least one locking element, a spring, a firing pin, a percussion cap, a charge, a cutting element, a stop and a shear pin, wherein the at least one locking element ensures a connection between the firing-pin holder and the firing pin. At a predetermined point in time, the spring is subjected to stressing, for example by means of the braking energy of a brake parachute. Once the firing-pin holder has covered a predetermined distance, the at least one locking element is freed. The freeing action gives rise to the spring being relieved of stressing, as a result of which the firing pin is accelerated and, at the end, strikes against the percussion cap. By virtue of the firing pin striking against the percussion cap, the pyrotechnic composition in the latter is ignited. By virtue of the pyrotechnic composition in the percussion cap being initiated, the delay element, if present, is ignited. Said element here regulates the delay time. The percussion cap or delay elements ignite a further charge. The resulting gas volume subjects the cutting element to pressure. Above a certain pressure, the shear pin is sheared, as a result of which the cutting element is accelerated axially. The cutting element strikes against the stop at high speed, resulting from the acceleration, and, in the process, penetrates into said stop. A connection which is to be cut, and is guided through an opening in front of the stop, is severed here.

The use of the aforementioned cutting device is not limited to the in the munition. The cutting device can be used wherever it is necessary to dispense with electrical energy, or other types of stored energy, for severing cords, bands or the like. It is thus also possible for the cutting device to be installed as an emergency system, that is to say as an emergency cable cutting in parachute systems in general, in addition to the conventional cutting mechanism. The emergency system can take effect when the actual, e.g. electric, cutting device fails. The parachute systems also cover those intended for people.

It is also conceivable to use the cutting device on for example protected vehicle cabs in respect of which various superstructures, subassemblies, etc., are connected to the vehicle structure by means of steel cables or the like. In this case, the firing pin would be subjected to stressing separately, and it should also be possible for the firing pin to be subjected to stressing manually.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exploded illustration of a cutting device according to the invention;

FIGS. 2-4 show a sectional illustration of the cutting device in the assembled state; and

FIG. 5 shows an alternative attachment option.

### DETAILED DESCRIPTION

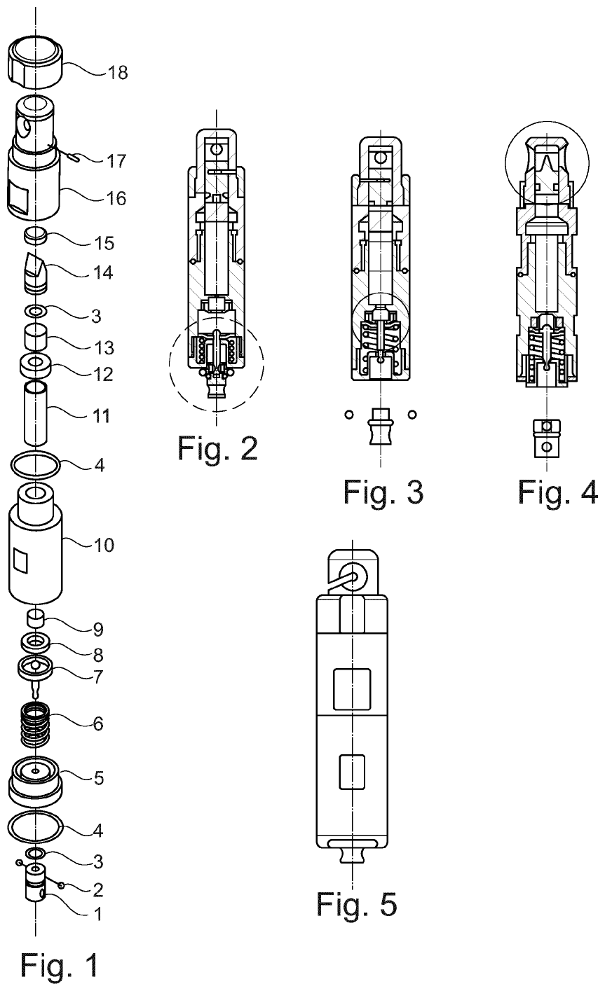

FIG. 1 illustrates a cutting device 20 having a firing-pin holder 1, at least one ball 2, two 0 rings 3, 4, which form sealing rings, a cover 5 and also a spring 6 and a firing pin 7. The cutting device 20 also comprises a cap 8, a percussion cap 9 and also a central piece 10 and a pyrotechnic delay element 11. A threaded sealing disk is denoted by 12, a propellant charge by 13, a chisel by 14 and a stop by 15. The cutting device 20 is completed by a shear pin 17, which is accommodated in a front casing 16. A union nut 18 retains the shear pin 17 in the front casing 16.

Functioning is as follows:

A tensile force pulls the firing-pin holder 1 out of the cover 5. The force necessary for this purpose is adjusted via the spring 6, in this case in the form of a compression spring. Once the firing-pin holder 1 has covered a predetermined distance, the at least one ball 2 (locking element) is freed. This at least one ball 2 constitutes the connection between the firing-pin holder 1 and the firing pin 7. As the ball(s) 2 is or are freed, the connection between the firing-pin holder 1 and the firing pin 7 is eliminated. This leads to the spring 6 being relieved of stressing. As a result of the spring 6 being relieved of stressing, the firing pin 7 is accelerated and, the end, strikes against the percussion cap 9. By virtue of the firing pin 7 striking against the percussion cap 9, the pyrotechnic composition therein is ignited. By virtue of the pyrotechnic composition in the percussion cap being initiated, the delay element 11 is ignited. The latter regulates the delay time. The delay time can be set as desired. It can even be 0 seconds. Once the delay element 11 has burnt out, a further pyrotechnic composition—propellant charge 13—is ignited at its end. The resulting gas volume subjects the cutting element 14, in this case the chisel, to pressure. Above a certain pressure, the shear pin 17 is sheared, as a result of which the cutting element 14 is accelerated axially. The cutting element 14 strikes against the stop 15 at high speed, resulting from the acceleration, and, in the process, penetrates into said stop. A connection which is to be cut, and is guided through an opening in front of the stop 15, is severed here.

FIG. 2 shows the cutting device 20 at the point in time at which the spring 6 has been subjected to stressing and the ball(s) 2 are freed. FIG. 3 illustrates the point in time at which the spring 6 has been relieved of stressing and the delay element 11 is being ignited. FIG. 4, in turn, follows the point in time at which the connection which is to be cut is severed.

FIG. 5 contains a variant for fitting the cutting device 20 in a system.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cutting device comprising:
at least one firing-pin holder;
at least one locking element;
at least one spring;
at least one firing pin;
a percussion cap;
a charge;
a cutting element;
a stop; and
a shear pin,
wherein the at least one locking element ensures a connection between the firing-pin holder and the firing pin.

2. The cutting device as claimed in claim 1, wherein a pyrotechnic delay element is arranged between the percussion cap and the propellant charge.

3. The cutting device as claimed in claim 1, wherein the shear pin is accommodated in a front casing.

4. The cutting device as claimed in claim 1, wherein the cutting element is a chisel.

5. A munition comprising:
submunitions with a brake parachute; and
a cutting device as claimed in claim 1 for severing a mechanical connection between the brake parachute and the submunition,
wherein the mechanical connection is located in an opening in front of the stop.

6. The munition as claimed in claim 5, wherein the munition is a munition for generating a decoy target.

7. A parachute system comprising a cutting device as claimed in claim 1, wherein a mechanical connection which is to be severed is arranged in an opening in front of the stop.

8. A vehicle having superstructures or subassemblies attached to a vehicle structure via mechanical connections and a cutting device as claimed in claim 1, wherein a mechanical connection which is to be severed is located in an opening in front of the stop.
